(19) United States
(12) Patent Application Publication
(10) Pub. No.: US 2025/0363268 A1
(43) Pub. Date: Nov. 27, 2025

(54) LAYOUT OPTIMIZATION DESIGN AND MANUFACTURING METHOD FOR DISCRETE TRUSS STRUCTURES BASED ON REPETITIVE UNITS

(71) Applicants: Shaoxing University, Shaoxing (CN); ZHEJIANG PROVINCE INSTITUTE OF ARCHITECTURAL DESIGN AND RESEARCH, Hangzhou (CN)

(72) Inventors: Zhen WANG, Shaoxing (CN); Jun YE, Shaoxing (CN); Yang ZHAO, Shaoxing (CN); Xuelin YANG, Shaoxing (CN); Haochuan QU, Shaoxing (CN); Yufeng LIU, Shaoxing (CN); Hongjia LU, Shaoxing (CN); Guan QUAN, Shaoxing (CN); Huiping TANG, Shaoxing (CN)

(21) Appl. No.: 19/294,022

(22) Filed: Aug. 7, 2025

Related U.S. Application Data
(63) Continuation of application No. PCT/CN2023/138769, filed on Dec. 14, 2023.

(30) Foreign Application Priority Data
Feb. 13, 2023 (CN) 202310141835.8

(51) Int. Cl. G06F 30/23; B29C 64/393; B33Y 50/02; G06F 111/04; G06F 113/10; G06F 119/18

(52) U.S. Cl. CPC G06F 30/23; B29C 64/393; B33Y 50/02; G06F 2111/04; G06F 2113/10; G06F 2119/18

(57) ABSTRACT

A layout optimization design and manufacturing method for discrete truss structures based on repetitive units includes: establishing a mathematical model for truss layout optimization, performing a direct solution based on repetitive units, conducting a two-step solution to first determine the unit layout, and carrying out 3D printing manufacturing and integrated assembly.

### CROSS-REFERENCE TO RELATED APPLICATIONS

This application is a continuation of International Application No. PCT/CN2023/138769, filed on Dec. 14, 2023, and claims priority to Chinese Patent Application No. 202310141835.8, filed on Feb. 13, 2023, the entire disclosure of which is incorporated herein by reference.

### TECHNICAL FIELD

The present application relates to the technical fields of structural engineering and additive manufacturing, and particularly to a layout optimization design and manufacturing method for discrete truss structures based on repetitive units.

### BACKGROUND

The increasing complexity of engineering requirements has led to a growing demand for optimized design and 3D printing integrated assembly of complex truss structures. Topological optimization of structures includes discrete and continuum structures, truss structure optimization widely used in practical engineering falls into the category of discrete structure topology optimization.

Layout optimization of truss structures is a linear programming problem. While traditional algorithms can achieve numerically optimal solutions, the resulting structures are often too complex to manufacture or even unfeasible for production. To reduce manufacturing costs, conventional approaches typically involve adding extra constraints such as bar classification and structural complexity limits to ensure the final design is feasible for fabrication. However, these constraints often complicate the optimization process. In contrast, the introduction of repetitive units offers a rational and efficient solution to simplify the layout optimization problem.

Optimization methods introducing the concept of repetitive units have been proposed in the process of continuum optimization, mainly including the Homogenization Method and the small-scale unified optimization method. The Homogenization Method equates micro-units to a macroscopically homogeneous medium, enabling a coarse-grained finite element analysis of the entire structure at the macroscopic level. However, without introducing additional constraints, the Homogenization Method cannot control the connectivity between units. The small-scale unified optimization method optimizes the entire structure at a relatively small scale, but at the cost of high computational expenses. Units in architectural engineering are generally discrete structures and have a finite size relative to the design domain; therefore, the aforementioned repetitive unit algorithms for continuum optimization cannot be directly applied to solve the layout optimization problem of truss structures.

In summary, there is a critical need to develop a method for optimizing the layout design and manufacturing of discrete truss structures based on repetitive units, enabling optimized layout, 3D printing fabrication, and integrated assembly of complex truss structures.

### SUMMARY

The purpose of the present application is to overcome the deficiencies in the prior art and provide a layout optimization design and manufacturing method for discrete truss structures based on repetitive units.

A structural layout optimization design and manufacturing method based on repetitive units, including:

Step S1: establishment of truss layout optimization mathematical model: defining a structural design domain, inputting dimensions, loading conditions, and boundary constraints, and specifying unit patterns and corresponding complexity of the unit pattern; discretizing the structural design domain using a lattice, connecting any two nodes to establish a minimal connection base structure; and establishing a linear optimization model for truss layout optimization with a mechanical equilibrium equation as constraints and a minimum total volume of bars as a design objective;

Step S2: direct solution based on repetitive units: setting a finite number of unit patterns and performing unit division to ensure all bars belong to a unit pattern and no bar crossing pattern, wherein units of a same pattern have identical layout and corresponding bar areas; using binary variables for activated unit patterns for each bar in a truss structure, adding repetitive unit constraints to form non-linear constraints; and converting a non-linear programming problem into a linear programming problem to enable direct optimization of repetitive units;

Step S3: two-step solution with a predefined unit layout: reducing a complexity of each unit pattern, solving by using Step S2 to obtain activated unit pattern variables t_{c} for each pattern; setting normal complexity for each unit pattern, substituting the activated unit pattern variables t_{c} into non-linear constraint expressions of repetitive units for each bar in Step S2 to convert into linear constraints, for solving again to obtain an optimized result;

Step S4: three-dimensional (3D) printing manufacturing and integrated assembly: creating a 3D model, slicing multiple repetitive units in an optimized model and generating printing paths, performing 3D printing; and assembling the repetitive units through integrated connection to manufacture an optimized structure.

In one embodiment, in Step S1: an objective function corresponding to a design objective of minimizing a total volume of bars is:

$${min}_{a , q} V = {l}^{T} a \qquad ( 1 )$$

constraint conditions are expressed as:

$$\{ \begin{matrix}\begin{matrix}Bq = f \\ - {σ}_{c} \cdot a \leq q \leq {σ}_{t} \cdot a\end{matrix} \\ a \geq 0\end{matrix} \qquad ( 2 )$$

where: l is a bar length vector, a is a bar area vector, B is an equilibrium matrix, q is a bar internal force vector, f is a node load vector, σ_{c} and σₗ are compressive and tensile strength vectors of bars respectively; three constraints in Equation (2) represent a force equilibrium equation, bar stress constraints, and non-negative bar area constraints respectively; design variables are the bar area vector a and bar internal force vector q; B and l are a constant matrice and a constant vector generated according to bar topology, while f, σ_{c}, and σₗ are constants determined by actual working conditions.

In one embodiment, in Step S1: when an equilibrium matrix of a minimal connection base structure is unable to be solved in an initial optimization state, increasing a bar length threshold and a grid density in the minimal connection base structure to form an updated base structure, and solving again.

In one embodiment, in Step S2: setting binary variables for activated unit patterns for each bar, adding repetitive unit constraints to each bar in the truss structure by filling the design domain with unit patterns, connecting nodes within each unit pattern to form bars as repetitive units; to ensure identical bar areas at corresponding positions in a same unit pattern type, when there are n unit pattern types, adding the following constraints for each bar:

$${t}_{c 1} + {t}_{c 2} + … + {t}_{c n} = 1 \qquad ( 3 )$$

$${a}_{i} = {a}_{m 1} \cdot {t}_{c 1} + {a}_{m 2} \cdot {t}_{c 2} + … + {a}_{m n} \cdot {t}_{c n} \qquad ( 4 )$$

where aᵢ is a cross-sectional area of the bar, c is an unit pattern number the bar belongs to, m is a position number of the bar within the unit pattern, t_{c1}, t_{c2}, . . . , t_{cn} are the binary variables of the activated unit pattern where the bar belongs to, each binary variable represents 1 for activated or 0 for not activated, aₘ₁, aₘ₂, . . . , aₘₙ are possible cross-sectional areas for a position of the bar in the unit pattern, in Equation (4), aₘ₁, aₘ₂, . . . , aₘₙ and t_{c1}, t_{c2}, . . . , t_{cn} are variables, and a multiplication of two variables forms a non-linear constraint.

In one embodiment, in Step S2: using a Big M method to convert a non-linear constraint of Equation (4) into a linear constraint, resulting in Equation (5):

$$\{ \begin{matrix}{a}_{m 1} + M \times ( {t}_{c 2} + {t}_{c 3} + … + {t}_{c n} ) \geq {a}_{i} \geq {a}_{m 1} - M \times ( {t}_{c 2} + {t}_{c 3} + … + {t}_{c n} ) \\ {a}_{m 2} + M \times ( {t}_{c 1} + {t}_{c 3} + … + {t}_{c n} ) \geq {a}_{i} \geq {a}_{m 2} - M \times ( {t}_{c 1} + {t}_{c 3} + … + {t}_{c n} ) \\ ⋮ \\ {a}_{m n} + M \times ( {t}_{c 1} + {t}_{c 2} + … + {t}_{c n} ) \geq {a}_{i} \geq {a}_{m n} - M \times ( {t}_{c 1} + {t}_{c 2} + … + {t}_{c ( n - 1 )} )\end{matrix}$$

where M is a constant; each row in Equation (5) represents a constraint of a unit pattern on the bar at the position; when the first unit pattern is activated for the unit pattern where aᵢ belongs to, t_{c1}=1 others are t_{cx}=0, at this time, a first row of Equation (5) becomes to aᵢ=aₘ₁, while other inequalities become slack; when the second unit pattern is activated for the unit pattern where aᵢ belongs t_{c2}=1 others are t_{cx}=0; at this time, the second row of the constraint equation (5) becomes aᵢaₘ₂, while the other inequalities are slack and inactive; by analogy, when a certain unit pattern is activated for the unit pattern where the bar belongs to, a corresponding row of constraints for the bar takes effect, and inequality constraints in other rows become slack.

In one embodiment, Step S3 specifically includes: reducing the complexity of the unit pattern by decreasing the number of nodes in the normal unit pattern structure to obtain a simplified unit pattern structure; performing a first solution by using the method described in Step S2 to determine the activated unit pattern variables t_{c} for each unit pattern, which is equivalent to obtaining the layout of unit patterns for each bar in the design domain; resetting the complexity of the unit pattern to normal and regenerating the structure; substituting the variables t_{c} obtained from the first solution into Equation (4) to transform the optimization problem into a linear programming problem, and directly performing the second solution.

In one embodiment, Step S4 specifically includes: extracting structural information of repetitive units from the optimization results, where the structural information comprises the repetitive unit pattern, position, connections, and cross-sectional dimensions of the bar; after assembling the bar and generating nodes for the repetitive unit, creating a 3D solid model; slicing each type of repetitive unit in the 3D solid model and generating printing paths for 3D printing manufacturing; and connecting printed repetitive units through integrated assembly to fabricate the optimized structure.

Advantages of the present application are as follows:
1) The layout optimization design and manufacturing method for discrete truss structures based on repetitive units provided by the present application introduces additional constraints and variables specific to repetitive units, and proposes a direct solving method based on repetitive units. This ensures that the truss layout optimization results feature repetitive units, making them relatively easy to manufacture. The direct solving method based on repetitive units can be used independently or provide a mathematical model for the two-step solving process that first determines the unit layout.
2) The layout optimization design and manufacturing method for discrete truss structures based on repetitive units provided by the present application, building on the direct solving method based on repetitive units, addresses the issue of excessive computation time when solving large-scale problems by proposing a two-step solving process: first solving the unit pattern layout, then optimizing the internal structure of the unit pattern. This clarifies the force transmission path of the structure and significantly improves computational efficiency with minimal impact on the volume of the final optimized structure.
3) The layout optimization design and manufacturing method for discrete truss structures based on repetitive units provided by the present application, based on the mathematical model of truss layout optimization, achieves unit repetition and structural regularity in layout optimization results by setting a limited number of unit patterns and adding repetitive unit constraints. It realizes fast and efficient solving of layout optimization based on repetitive units through the two-step solving process first with simplified unit complexity, then with normal unit complexity. Additionally, it enables 3D printing optimization design and integrated assembly manufacturing of complex discrete truss optimized structures through 3D modeling, slicing of repetitive unit models, generation of printing paths, and integrated assembly production.

### BRIEF DESCRIPTION OF THE DRAWINGS

To better illustrate the technical solutions in the embodiments of the present application or the related art, the accompanying drawings required in the embodiments will be briefly introduced below. Obviously, the drawings described below are only some embodiments of the present application. For those skilled in the art, other drawings can also be obtained based on these drawings without creative work.

FIG. 1 is a specific flow chart of the design and manufacturing method for discrete truss layout optimization based on repetitive units according to the present application.

FIG. 2a is a schematic diagram of unit complexity 2×2.

FIG. 2b is a schematic diagram of unit complexity 3×3.

FIG. 2c is a schematic diagram of unit complexity 4×4.

FIG. 3 is a schematic diagram of a cantilever beam structure model.

FIG. 4 is a schematic diagram of the ordinary layout optimization result in step S1 for the cantilever beam structure.

FIG. 5a is a schematic diagram of the layout optimization result of the direct solution in step S2 for the cantilever beam structure.

FIG. 5b shows four repetitive units when the corresponding unit pattern complexity is 4×4 and the number of unit patterns is 4 in the direct solution of step S2 for the cantilever beam structure.

FIG. 6a is a first solution result of the two-step solution in step S3 when the simplified and normal unit pattern complexities of the cantilever beam structure are 2×2 and 4×4 respectively.

FIG. 6b is a corresponding second solution result of the cantilever beam structure.

FIG. 7a is the first solution result of the two-step solution in step S3 when the simplified and normal unit pattern complexities of the cantilever beam structure are 3×3 and 4×4 respectively.

FIG. 7b is the corresponding second solution result of the cantilever beam structure.

FIG. 8a is the second solution result of the two-step solution in step S3 when the simplified and normal unit pattern complexities of the cantilever beam structure are 3×3 and 6×6 respectively.

FIG. 8b is the second solution result of the two-step solution in step S3 when the simplified and normal unit pattern complexities of the cantilever beam structure are 3×3 and 8×8 respectively.

FIG. 9 is a schematic diagram of a frame-brace structure model under horizontal wind load.

FIG. 10a is the second solution result of the two-step solution in step S3 when the number of repetitive unit patterns of the frame-brace structure is 1.

FIG. 10b is the second solution result of the two-step solution in step S3 when the number of repetitive unit patterns of the frame-brace structure is 4.

### DETAILED DESCRIPTION OF THE EMBODIMENTS

The present application will be further described below in conjunction with the embodiments. The description of the following embodiments is only for helping to understand the present application. It should be pointed out that for those skilled in the technical field, without departing from the principle of the present application, several modifications can also be made to the present application, and these improvements and modifications also fall within the protection scope of the claims of the present application.

### Embodiment 1

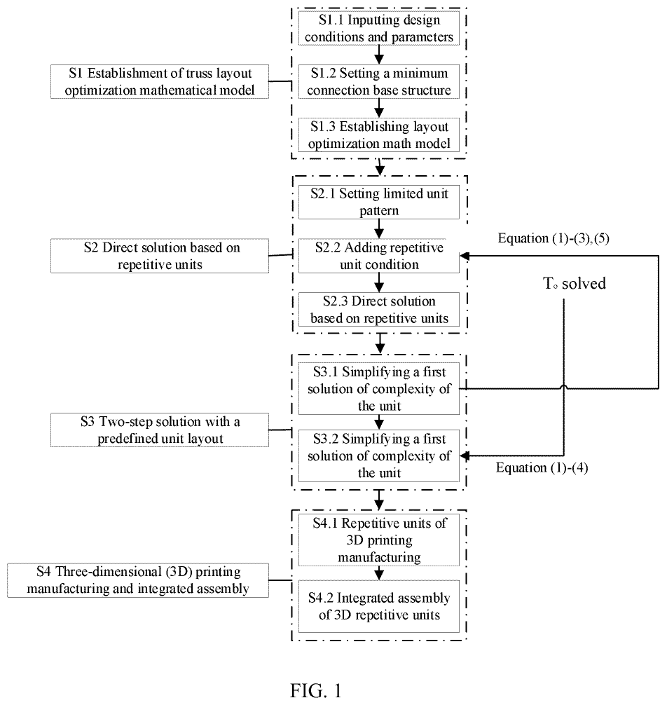

As an embodiment, as shown in FIG. 1, a layout optimization design and manufacturing method for discrete truss structures based on repetitive units; 3D printing technology, also known as additive manufacturing technology, realizes the generation of structures through layer-by-layer accumulation of materials, which greatly broadens the flexibility of structural manufacturing. Good optimization results can be obtained through structural layout optimization based on repetitive units, including the arrangement and combination of repetitive units, and then 3D printing and integrated assembly are carried out for a few complex configuration repetitive units to realize the integrated manufacturing of the optimized complex truss structure; it specifically includes the following steps:
S1. Establishment of truss layout optimization mathematical model: first, giving the structural design domain, input constraint conditions and parameters, establishing a minimal connection base structure, taking a mechanical equilibrium equation as the constraint condition, taking a minimum total volume of bars as a design objective, and establishing a linear optimization model; specifically including the following steps:
S1.1 Inputting design conditions and parameters: inputting the design domain size, load conditions and boundary constraints, and specifying the unit pattern and corresponding unit complexity.
S1.2 Establishing a minimal connection base structure: discretizing the design domain by using a uniform lattice, and connecting any two nodes to form a minimal connection base structure.
S1.3 Establishing a layout optimization mathematical model: the underlying layer of the optimization algorithm is a mathematical optimization problem. Taking the mechanical equilibrium equation as the constraint condition and the minimum total volume of bars as the design objective, a linear optimization model for truss layout optimization is established.

The objective function is

$${min}_{a , q} V = {l}^{T} a \qquad ( 1 )$$

constraint conditions are expressed as:

$$\{ \begin{matrix}\begin{matrix}Bq = f \\ - {σ}_{c} \cdot a \leq q \leq {σ}_{t} \cdot a\end{matrix} \\ a \geq 0\end{matrix} \qquad ( 2 )$$

where l is a bar length vector, a is a bar area vector, B is an equilibrium matrix, q is a bar internal force vector, f is a node load vector, σ_{c} and σₜ are compressive and tensile strength vectors of bars respectively.

The objective function (1) represents an optimization goal of minimizing volume, while the constraint conditions (2) represent the force equilibrium equation, stress constraints of the bars, and non-negative constraints on the bar areas. This problem is a linear programming problem, where the design variables are the bar area vector a and the bar internal force vector q. B and l are respectively the constant matrix and constant vector f generated according to the bar topology, while σ_{c}, σₜ of are all constants determined by actual working conditions.

After specifying the design domain for truss layout optimization, a structure is determined through a certain method based on equations (1) and (2) to calculate the required constants. To ensure the theoretically optimal result, the simplest way to determine the structure is to connect all nodes in the design domain pairwise, thereby creating a minimal connection base structure that includes all possible bars. Although the structure obtained through ordinary truss layout optimization saves material and is mechanically reasonable, it is often overly complex and difficult to manufacture.

If the equilibrium matrix of the minimal connection base structure cannot be solved in the initial optimization state, the member length threshold and grid density in the minimal connection base structure are increased to form an updated minimal connection base structure for the initial optimization state, and then solve it again.
Step S2: direct solution based on repetitive units: setting a finite number of unit patterns and performing unit division to ensure all bars belong to a unit pattern and no bar crossing pattern, adding repetitive unit constraints to each bar in the truss structure and perform direct optimization solution; specifically as follows:
S2.1 Setting a finite number of unit patterns: defining a limited number of unit patterns such that all bars belong to only one unit pattern, with no bars spanning multiple patterns. Bars in the same unit pattern must have identical layouts and cross-sectional areas. Truss layout optimization based on repetitive units has two key characteristics: (1) all bars are assigned to specific unit patterns with no overlaps; (2) all units follow a finite set of patterns, with identical layouts and bar areas for the same pattern. To implement a repetitive unit structure, first the design domain is filled with units, then all pairs of nodes within each unit are connected to form bars. The number of bars in a repetitive unit structure is significantly reduced compared to the truss optimization in Step S1.
S2.2 Incorporate repetitive unit constraints: using binary variables to activate unit patterns for each bar and adding repetitive unit constraints to every bar in the truss structure.

To ensure that bars in the same position across the same type of unit pattern have the same area, taking a structure with n unit patterns as an example, add the following constraints to each bar:

$${t}_{c 1} + {t}_{c 2} + … + {t}_{c n} = 1 \qquad ( 3 )$$

$${a}_{i} = {a}_{m 1} \cdot {t}_{c 1} + {a}_{m 2} \cdot {t}_{c 2} + … + {a}_{m n} \cdot {t}_{c n} \qquad ( 4 )$$

where aᵢ is a cross-sectional area of the bar, c is an unit pattern number the bar belongs to, m is a position number of the bar within the unit pattern, t_{c1}, t_{c2}, . . . , t_{cn} are the binary variables of the activated unit pattern where the bar belongs to, each binary variable represents 1 for activated or 0 for not activated, aₘ₁, aₘ₂, . . . , aₘₙ are possible cross-sectional areas for a position of the bar in the unit pattern, in Equation (4), aₘ₁, aₘ₂, . . . , aₘₙ and t_{c1}, t_{c2}, . . . , t_{cn} are variables, and a multiplication of two variables forms a non-linear constraint. This leads to difficulties in solving the problem, necessitating its transformation into a linear problem that can be directly solved.

S 2.3 Direct Solution Based on Repetitive Units: using a Big M method to convert a non-linear constraint of Equation (4) into a linear constraint, resulting in Equation (5):

$$\{ \begin{matrix}{a}_{m 1} + M \times ( {t}_{c 2} + {t}_{c 3} + … + {t}_{c n} ) \geq {a}_{i} \geq {a}_{m 1} - M \times ( {t}_{c 2} + {t}_{c 3} + … + {t}_{c n} ) \\ {a}_{m 2} + M \times ( {t}_{c 1} + {t}_{c 3} + … + {t}_{c n} ) \geq {a}_{i} \geq {a}_{m 2} - M \times ( {t}_{c 1} + {t}_{c 3} + … + {t}_{c n} ) \\ ⋮ \\ {a}_{m n} + M \times ( {t}_{c 1} + {t}_{c 2} + … + {t}_{c n} ) \geq {a}_{i} \geq {a}_{m n} - M \times ( {t}_{c 1} + {t}_{c 2} + … + {t}_{c ( n - 1 )} )\end{matrix}$$

where M is a constant; each row in Equation (5) represents a constraint of a unit pattern on the bar at the position; when the first unit pattern is activated for the unit pattern where aᵢ belongs to, t_{c1}=1 others are t_{cx}=0, at this time, a first row of Equation (5) becomes to aᵢ=aₘ₁, while other inequalities become slack; when the second unit pattern is activated for the unit pattern where aᵢ belongs to, t_{c2}=1 others are t_{cx}=0; at this time, the second row of the constraint equation (5) becomes aᵢ=aₘ₂, while the other inequalities are slack and inactive; by analogy, when a certain unit pattern is activated for the unit pattern where the bar belongs to, a corresponding row of constraints for the bar takes effect, and inequality constraints in other rows become slack. Equation (5) can achieve the same effect as Equation (4), and Equation (5) remains a linear constraint, which does not change the linear programming characteristics of the optimization problem and facilitates solving.

The truss layout optimization based on repetitive units is a linear programming problem with Equation (1) as the objective function and Equations (2), (3) and (5) as constraints.

The truss layout optimization based on repetitive units is a mixed-integer programming problem, including general continuous variables and binary integer variables due to the introduction of t_{c}. The Gurobi commercial solver, which is good at such problems, is used for direct solution; this solver has an interface for Python, making it easy to call programs.

S3. Two-step Solution for First Determining Unit Layout: first, setting a lower level of unit pattern complexity, using Step S2 for the first solution to obtain the activated unit pattern variables t_{c}, substituting them into Equation (4), and discarding the constraint of Equation (5), thereby converting it into a linear constraint for the second solution; specifically as follows:

S3.1 First Solution with Simplified Unit Complexity: due to the characteristics of mixed-integer programming in solution, the method in Step S2 will have the problem of excessively long calculation time as the design domain becomes larger, the number of unit patterns increases, or the unit pattern complexity becomes higher; in mixed-integer programming, both the number of integer variables and the number of continuous variables affect the solution time, where the number of integer variables depends on the number of unit patterns and the number of unit patterns, these two parameters are determined by specific problems and design requirements and should not be modified arbitrarily, while the number of continuous variables depends on the number of bars in the structure, and the number of bars is determined by the number of repetitive units and the unit pattern complexity; the only variable that can be improved in the calculation process is the unit pattern complexity; therefore, first the complexity of the unit pattern is set to a lower level, and the Step S2 is used for the first solution, which is a mixed-integer linear programming problem, to obtain the unit pattern variables t_{c} activated by each unit pattern.

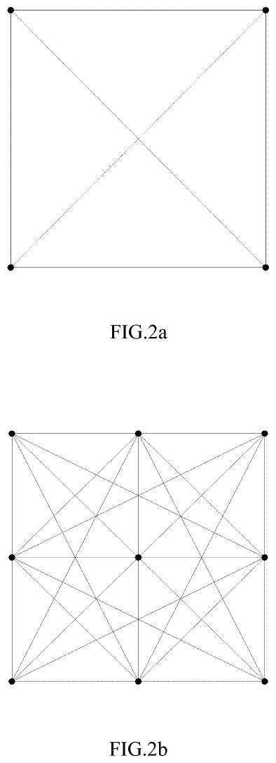

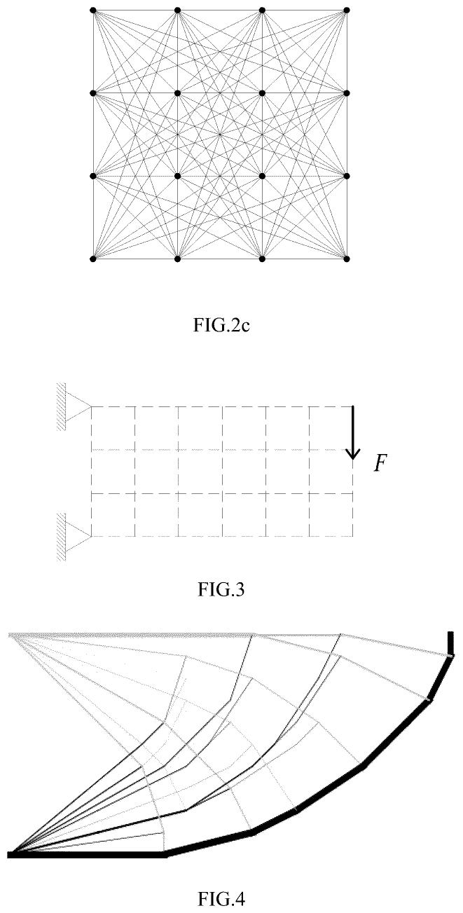

As shown in FIGS. 2a-2c, they are units with general complexities of 2×2, 3×3 and 4×4 respectively. The unit pattern complexity nₓ×n_{y} represents the number of nodes in the horizontal and vertical directions within the unit pattern; the higher the unit pattern complexity, the higher the degree of freedom of the structure, and theoretically, a better objective function value will be obtained, but correspondingly, this will make the structure contain more bars and the solution time will be longer.

First, the complexity of the unit mode is set to a relatively low level, the first solution is performed using the method in step S2, to obtain the unit mode variables t_{c} activated by each unit mode, which is equivalent to finding the layout of the unit mode adopted by each unit mode in the design domain.

S3.2 Second Solution with Normal Unit Complexity: then resetting the unit pattern complexity to the normal level and regenerate the structure, substituting the variables obtained from the first solution into Equation (4) and discarding Constraint of Equation (5). Since t_{c} is now determined constant vectors at this time, Equation (4) preserves the linear programming nature of the optimization problem. Moreover, as there are no binary integer variables left, the second solution is no longer a mixed-integer programming problem. Its computation time is far shorter than that of the first solution, accounting for almost negligible time in the entire solving process.

The computation time of mixed-integer programming is the decisive factor for the overall optimization duration. In the first solution of the improved algorithm in Step S3, due to the lower complexity of unit patterns and fewer continuous variables, the computation time can be significantly reduced compared to that of a single solution in Step S2. However, the results of the improved algorithm in Step S3 cannot be guaranteed to be completely consistent with those of the algorithm described in Step S2, because the first solution actually only determines the layout of various unit patterns without providing the internal structures of specific unit patterns. Under normal circumstances, bars with relatively similar stress levels under loads will adopt the same type of unit pattern, but the number of unit patterns and the complexity of unit patterns during the first solution may affect the layout results of unit patterns.

Increasing the number of unit patterns is more beneficial than improving the complexity of normal unit patterns for obtaining a better structure. However, under permissible conditions, the complexity of the simplified unit patterns in the two-step solution should not be too low; otherwise, it may cause the layout of the unit patterns to deviate from the optimal one.

S4. 3D Printing and Integrated Assembly: Creating a 3D model, slicing various repetitive units in the solid model respectively, generating printing paths, carrying out 3D printing manufacturing, and performing integrated assembly between the repetitive units to produce the optimized structure; specifically as follows:

S4.1 3D Printing of Repetitive Units: 3D modeling is performed using Rhino software, and Cura software is used to slice various repetitive units in the solid model obtained from 3D modeling and generate printing paths. Structural information of repetitive units is extracted from the optimization results, which includes repetitive unit patterns, repetitive unit positions, repetitive unit connections, and cross-sectional dimensions of repetitive unit bars. After processing such as bar assembly and node generation of repetitive units, a 3D solid model is established. Then, various repetitive units in the solid model are sliced respectively, printing paths are generated, and 3D printing manufacturing is carried out.

S4.2 Integrated Assembly of Repetitive Units: the repetitive units are connected by means of welding, bolting, etc., and integrated assembly is carried out to manufacture the optimized structure.

### Embodiment 2

As another embodiment, this embodiment demonstrates the optimal design and manufacturing for a cantilever beam problem through the ordinary layout optimization in Step S1 and the direct solution based on repetitive units in Step S2 in Embodiment 1.

As shown in FIG. 3, the design domain of the cantilever beam has a width of 6 and a height of 3, with each unit having a height and width of 1. The design domain contains a total of 6×3=18 units. A vertical downward unit load acts on the top-right corner of the design domain, and the horizontal and vertical degrees of freedom are constrained at the upper and lower nodes on the left side. All involved quantities are dimensionless; the self-weight of the structure is ignored, and both the allowable tensile stress and allowable compressive stress of the bars are taken as σ_{c}=σₜ=1. The initial values of the design variable including a bar area vector a and the bar internal force vector q are both set to 0. The calculations are performed on a workstation with an Intel i7-12700K CPU (3.61 GHz) and 32 GB of running memory.

In this example, the structure obtained from the ordinary layout optimization in the Step S1 saves materials and has reasonable stress distribution, but its structure is often too complex to manufacture. A schematic diagram of the optimization result is shown in FIG. 4, where light-colored bars represent tension, dark-colored bars represent compression, the thickness of the bars indicates their cross-sectional area, and bars with an area smaller than a threshold, which is set to 1/1000 of the maximum bar area in the structure, are not displayed.

On this basis, Step S2 is further implemented in this example: direct solution based on repetitive units, with the unit complexity set to 4×4 and the number of repetitive unit patterns set to 4. A schematic diagram of the direct optimization result is shown in FIG. 5a, and schematic diagrams of the 4 repetitive unit structures are shown in FIG. 5b. The volume of the structure obtained by direct solution is 32, with a solution time of 20498seconds. The force transmission path of the optimized structure is similar to that of the ordinary layout optimization, but since there are no bars spanning multiple unit patterns, the differences in bar lengths are not significant, and the number of bars connected to a single node is limited, with no overly complex nodes. Compared with the ordinary layout optimization result in Step S1, Step S2 greatly reduces the manufacturing difficulty of the structure.

This example demonstrates the application of some steps in the present application to truss structure layout optimization, showing that the equations based on repetitive units established in Step S2 can be directly used for the optimal solution of repetitive units, achieving good results.

### Embodiment 3

As another embodiment, according to the layout optimization design and manufacturing method for discrete truss structures based on repetitive units proposed in Embodiment 1, aiming at the same cantilever beam problem in Embodiment 2, the two-step solution in Step S3 is further carried out by means of the direct solution method based on repetitive units in Step S2.

The complexity of the normal unit pattern is set to 4×4, and the number of repetitive unit patterns is set to 4. In the two-step solution of Step S3, the complexity of the simplified unit patterns is set to 2×2 and 3×3 respectively.

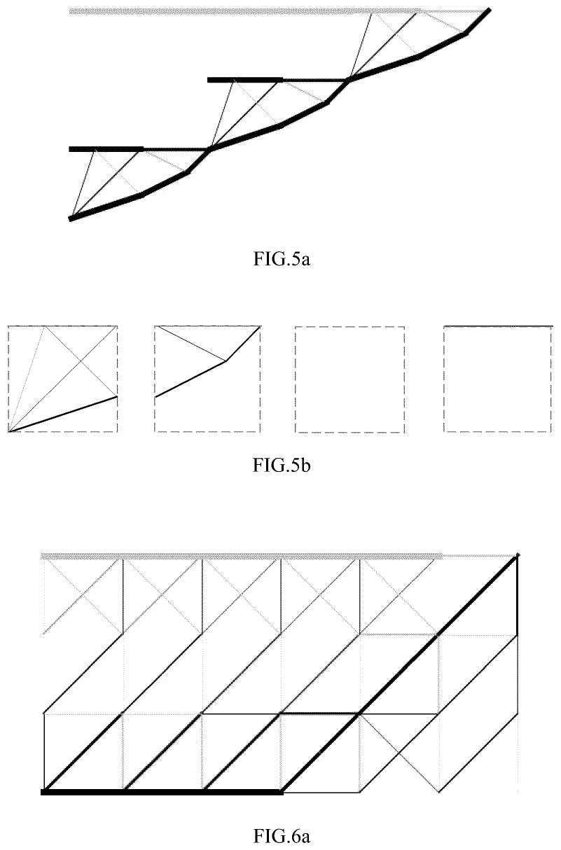

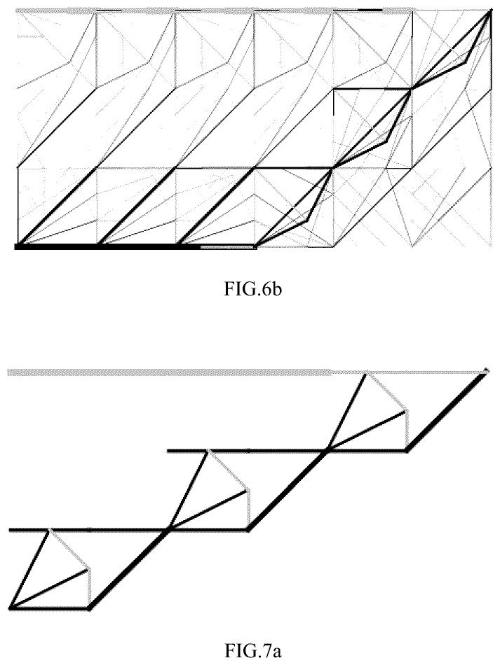

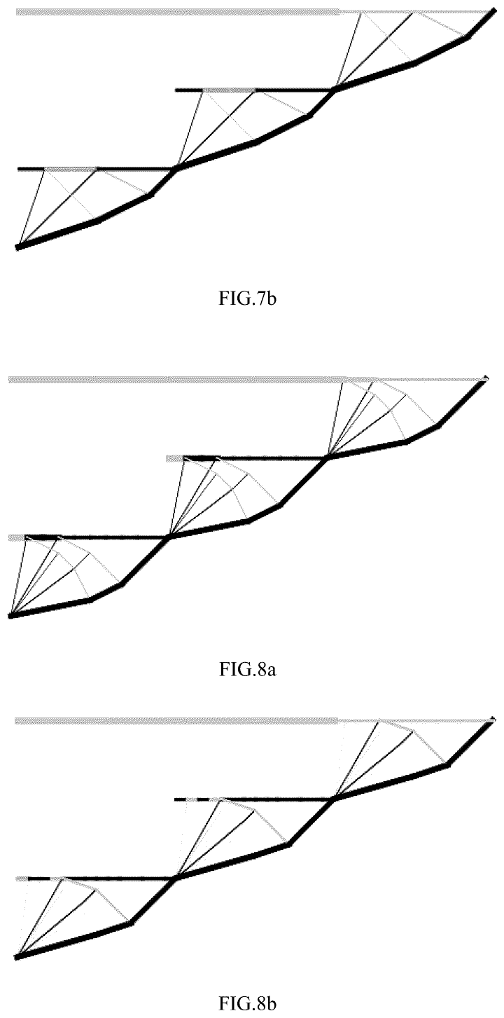

In this embodiment, the schematic diagram of the optimization results of the two-step solution in Step S3 when the complexity of the simplified and normal unit patterns is 2×2 and 4×4 respectively is shown in FIG. 6. The schematic diagram of the optimization results of the two-step solution in Step S3 when the complexity of the simplified and normal unit patterns is 3×3 and 4×4 respectively is shown in FIG. 7.

The specific optimization results are as follows:

| | Complexity of the | | The number | | | |
|---|---|---|---|---|---|---|
| | unit pattern | | of the unit | Structural volume | | Solution |
| Optimization | Simplification | normal | pattern | First time | Second time | time (s) |
| S2 direct | 4 × 4 | | 4 | 32 | | 20498 |
| solution | | | | | | |
| S3 two-step | 2 × 2 | 4 × 4 | 4 | 34.400 | 33.688 | 25 |
| solution | 3 × 3 | 4 × 4 | 4 | 33 | 32 | 4241 |
| | | 6 × 6 | 4 | / | 31.486 | / |
| | | 8 × 8 | 4 | / | 34.530 | / |

When the complexity of the simplified unit pattern is 2×2: the structural volume obtained by the direct solution in Step S2 is 32, with a solution time of 20498 s. The structural volumes obtained by the two-step solution in Step S3 are 34.400 and 33.688 respectively. Compared with the direct solution, the volume increases by 5.28%, but the solution time is greatly reduced to only 25 s, which is about 1/800 of that of the direct solution, showing a significant improvement in computational efficiency.

When the complexity of the simplified unit pattern is 3×3: the structural volumes obtained by the two-step solution in Step S3 are 33 and 32 respectively. The final volume is consistent with that of the direct solution, while the calculation time is 4241 s, which is about ⅕ of that of the direct solution, with a significant improvement in computational efficiency.

In this embodiment, there are significant differences in the structural layout and form when the complexity of the simplified unit pattern is 2×2 and 3×3. The increase in the complexity of the simplified unit pattern makes the unit layout result of the first-step solution closer to the ideal situation, thus making the final structure closer to the result of the direct solution. Therefore, under permissible conditions, ensuring the complexity of the simplified unit pattern is conducive to obtaining a scheme closer to the optimal layout.

When the complexity of the simplified unit pattern is 3×3: the second solution results of the two-step solution in Step S3 when the complexity of the normal unit pattern is 6×6 and 8×8 are shown in FIG. 8a and FIG. 8b respectively. Compared with the case when the complexity of the normal unit pattern is 4×, the overall layout of the structure is similar, but the internal details of the unit pattern are more complex. The final volumes of the corresponding structures are 31.486 and 31.530 respectively, which differ by only about 1.5% from that when the unit pattern complexity is 4×4, but the calculation time increases rapidly.

This embodiment demonstrates the application of some steps in the present application to truss structure layout optimization, showing that the two-step solution in Step S3 is solved by using the solution equations based on repetitive units established in Step S2, to achieve good results. The two-step solution, which first solves the unit pattern layout and then optimizes the internal structure of the unit pattern, makes the structural force transmission path clearer, and significantly improves computational efficiency with little impact on the volume of the final optimized structure, and can be used to solve the problem of excessive calculation time when dealing with large-scale problems.

### Embodiment 4

The optimization idea for repetitive units in truss-like discrete structures is as follows: First, defining the structural design domain, setting a limited number of unit patterns, and performing unit division. Finally, the overall structure is composed of multiple repetitive units with complex configurations. This allows the use of 3D printing to mass-produce a small number of unit patterns, and then performs simple integrated assembly. However, current research on the optimization of truss repetitive unit structures is scarce and does not involve layout optimization. Most existing repetitive unit structures adopt the same unit pattern within the same sub-design domain, i.e., the number of repetitive unit patterns is set to 1. This is partly determined by the characteristics of the homogenization method, but such restrictions do not apply to truss structures. The unit pattern selected for each bar has no inherent connection with its position, making the layout of the final structure more flexible. Therefore, the improved application of reasonable and effective repetitive unit algorithms is a key factor in truss structure layout optimization.

As another embodiment, this example applies the layout optimization design and manufacturing method for discrete truss structures based on repetitive units proposed in Embodiment 1 to perform the two-step solution in Step S3 for the frame-brace structure under horizontal wind loads, and compares the result differences under different numbers of unit patterns.

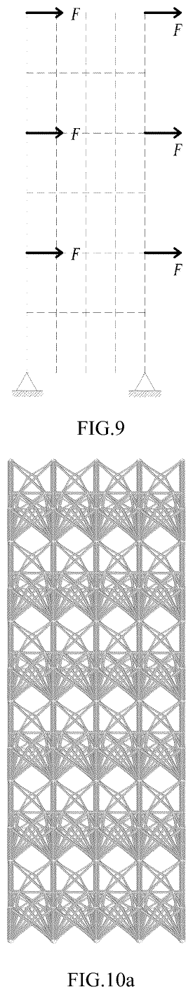

As shown in FIG. 9, the design domain of the frame-brace structure under horizontal wind loads has a width of 4 and a height of 12, with each unit having a height of 2 and a width of 1. The design domain contains a total of 6×3=18 units. Horizontal rightward unit loads act on both sides at heights of 4, 8, and 12, and the horizontal and vertical degrees of freedom are constrained at the two end nodes of the bottom edge. The complexity of the simplified unit pattern is set to 2×2, the complexity of the normal unit pattern is 6×6, and the number of repetitive unit patterns is set to 1 and 4 respectively.

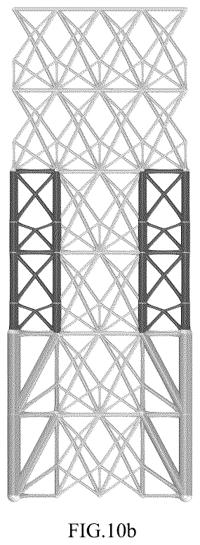

In this embodiment, the schematic diagrams of the optimization results of the two-step solution in Step S3 when the number of repetitive unit patterns is 1 and 4 are shown in FIG. 10; the specific optimization results are as follows:

| | The complexity of the | | The number | | | |
|---|---|---|---|---|---|---|
| Optimization | unit pattern | | of unit | Structural volume | | Solution |
| method | simplification | normal | patterns | First time | Second time | time (s) |
| S3 two-step | 2 × 2 | 2 × 2 | 1 | 1082.47 | 1082.47 | / |
| solution | | | 4 | 300.43 | 295.33 | 1852 |

Step S3 Two-Step Solution: when the number of repetitive unit patterns is 1, i.e., all unit patterns have the same unit structure, the structural volume from the second solution is 1082.47; when the number of repetitive unit patterns is 4, i.e., there are four different unit structures, the structural volumes from the first and second solutions are 300.43 and 295.33 respectively, with a solution time of 1852 s.

It can be seen that increasing the number of repetitive unit patterns reduces the structural volume, which is only about 30% of that when the number of repetitive unit patterns is 1. The optimization effect is significant, indicating that under large load conditions, appropriately increasing the number of repetitive unit patterns can better exert the advantage of material saving.

From Embodiments 2, 3, and 4, it can be concluded that the layout optimization design and manufacturing method for discrete truss structures based on repetitive units provided by the present application introduces additional constraints and variables targeting the characteristics of repetitive units. The proposed direct solution based on repetitive units makes the truss layout optimization results relatively easy to manufacture due to the characteristics of repetitive units. To address the problem of excessive calculation time in solving large-scale problems, the two-step solution, first solving the unit pattern layout and then optimizing the internal structure of unit patterns, is adopted, which clarifies the structural force transmission path and significantly improves computational efficiency with little impact on the volume of the final optimized structure. Thus, it realizes the 3D printing optimization design and integrated assembly manufacturing of complex discrete truss optimized structures. Moreover, practical verification has confirmed the effectiveness of the method of the present application.

Specific examples are used in the present application to illustrate the principles and implementations. The descriptions of the above examples are only intended to help understand the method and core idea of the present application. Meanwhile, for those skilled in the art, there will be changes in specific implementations and application scopes based on the idea of the present application. In conclusion, the content of this specification should not be construed as a limitation to the present application.

What is claimed is:

1. A structural layout optimization design and manufacturing method based on repetitive units, comprising:
Step S1: establishment of truss layout optimization mathematical model defining a structural design domain, inputting dimensions, loading conditions, and boundary constraints, and specifying unit patterns and corresponding complexity of the unit pattern; discretizing the structural design domain using a lattice, connecting any two nodes to establish a minimal connection base structure; and establishing a linear optimization model for truss layout optimization with a mechanical equilibrium equation as constraints and a minimum total volume of bars as a design objective;
Step S2: direct solution based on repetitive units
setting a finite number of unit patterns and performing unit division to ensure all bars belong to a unit pattern and no bar crossing pattern, wherein units of a same pattern have identical layout and corresponding bar areas;
using binary variables for activated unit patterns for each bar in a truss structure, adding repetitive unit constraints to form non-linear constraints; and converting a non-linear programming problem into a linear programming problem to enable direct optimization of repetitive units;
Step S3: two-step solution with a predefined unit layout
reducing a complexity of each unit pattern, solving by using Step S2 to obtain activated unit pattern variables t_{c} for each pattern;
setting normal complexity for each unit pattern, substituting the activated unit pattern variables t_{c} into non-linear constraint expressions of repetitive units for each bar in Step S2 to convert into linear constraints, for solving again to obtain an optimized result;
Step S4: three-dimensional (3D) printing manufacturing and integrated assembly
creating a 3D model, slicing multiple repetitive units in an optimized model and generating printing paths, performing 3D printing; and assembling the repetitive units through integrated connection to manufacture an optimized structure.

2. The method according to claim 1, wherein in Step S1: an objective function corresponding to a design objective of minimizing a total volume of bars is:
$${min}_{a , q} V = {l}^{T} a \qquad ( 1 )$$
constraint conditions are expressed as:
$$\{ \begin{matrix}\begin{matrix}Bq = f \\ - {σ}_{c} \cdot a \leq q \leq {σ}_{t} \cdot a\end{matrix} \\ a \geq 0\end{matrix} \qquad ( 2 )$$
where: l is a bar length vector, a is a bar area vector, B is an equilibrium matrix, q is a bar internal force vector, f is a node load vector, σ_{c} and σₜ are compressive and tensile strength vectors of bars respectively;
three constraints in Equation (2) represent a force equilibrium equation, bar stress constraints, and non-negative bar area constraints respectively;
design variables are the bar area vector a and bar internal force vector q; B and I are a constant matrice and a constant vector generated according to bar topology, while f, σ_{c}, and σₜ are constants determined by actual working conditions.

3. The method according to claim 2, wherein in Step S1: when an equilibrium matrix of a minimal connection base structure is unable to be solved in an initial optimization state, increasing a bar length threshold and a grid density in the minimal connection base structure to form an updated base structure, and solving again.

4. The method according to claim 1, wherein in Step S2: setting binary variables for activated unit patterns for each bar, adding repetitive unit constraints to each bar in the truss structure by filling the design domain with unit patterns, connecting nodes within each unit pattern to form bars as repetitive units; to ensure identical bar areas at corresponding positions in a same unit pattern type, when there are n unit pattern types, adding the following constraints for each bar:
$${t}_{c 1} + {t}_{c 2} + … + {t}_{c n} = 1 \qquad ( 3 )$$
$${a}_{i} = {a}_{m 1} \cdot {t}_{c 1} + {a}_{m 2} \cdot {t}_{c 2} + … + {a}_{m n} \cdot {t}_{c n} \qquad ( 4 )$$
where aᵢ is a cross-sectional area of the bar, c is an unit pattern number the bar belongs to, m is a position number of the bar within the unit pattern, t_{c1}, t_{c2}, . . . , t_{cn} are the binary variables of the activated unit pattern where the bar belongs to, each binary variable represents 1 for activated or 0 for not activated, aₘ₁, aₘ₂, . . . , aₘₙ are possible cross-sectional areas for a position of the bar in the unit pattern, in Equation (4), aₘ₁, aₘ₂, . . . , aₘₙ and t_{c1}, t_{c2}, . . . , t_{cn} are variables, and a multiplication of two variables forms a non-linear constraint.

5. The method according to claim 4, wherein in Step S2: using a Big M method to convert a non-linear constraint of Equation (4) into a linear constraint, resulting in Equation (5):
$$\{ \begin{matrix}{a}_{m 1} + M \times ( {t}_{c 2} + {t}_{c 3} + … + {t}_{c n} ) \geq {a}_{i} \geq {a}_{m 1} - M \times ( {t}_{c 2} + {t}_{c 3} + … + {t}_{c n} ) \\ {a}_{m 2} + M \times ( {t}_{c 1} + {t}_{c 3} + … + {t}_{c n} ) \geq {a}_{i} \geq {a}_{m 2} - M \times ( {t}_{c 1} + {t}_{c 3} + … + {t}_{c n} ) \\ ⋮ \\ {a}_{m n} + M \times ( {t}_{c 1} + {t}_{c 2} + … + {t}_{c n} ) \geq {a}_{i} \geq {a}_{m n} - M \times ( {t}_{c 1} + {t}_{c 2} + … + {t}_{c ( n - 1 )} )\end{matrix}$$
where M is a constant; each row in Equation (5) represents a constraint of a unit pattern on the bar at the position; when the first unit pattern is activated for the unit pattern where aᵢ belongs to, t_{c1}=1 others are t_{cx}=0, at this time, a first row of Equation (5) becomes to aᵢ=aₘ₁, while other inequalities become slack; when the second unit pattern is activated for the unit pattern where aᵢ belongs to, t_{c2}=1 others are t_{cx}=0; at this time, the second row of the constraint equation (5) becomes aᵢ=aₘ₂, while the other inequalities are slack and inactive; by analogy, when a certain unit pattern is activated for the unit pattern where the bar belongs to, a corresponding row of constraints for the bar takes effect, and inequality constraints in other rows become slack.

6. The method according to claim 4, wherein Step S3 specifically comprises:
reducing the complexity of the unit pattern by decreasing the number of nodes in the normal unit pattern structure to obtain a simplified unit pattern structure;
performing a first solution by using the method described in Step S2 to determine the activated unit pattern variables t_{c} for each unit pattern, which is equivalent to obtaining the layout of unit patterns for each bar in the design domain;
resetting the complexity of the unit pattern to normal and regenerating the structure;
substituting the variables t_{c} obtained from the first solution into Equation (4) to transform the optimization problem into a linear programming problem, and directly performing the second solution.

7. The method according to claim 1, wherein Step S4 specifically comprises:
extracting structural information of repetitive units from the optimization results, where the structural information comprises the repetitive unit pattern, position, connections, and cross-sectional dimensions of the bar;
after assembling the bar and generating nodes for the repetitive unit, creating a 3D solid model;
slicing each type of repetitive unit in the 3D solid model and generating printing paths for 3D printing manufacturing; and
connecting printed repetitive units through integrated assembly to fabricate the optimized structure.
